(19) United States
(12) Patent Application Publication
(10) Pub. No.: US 2006/0139858 A1
(43) Pub. Date: Jun. 29, 2006

(54) Miniature switchgear devices

(76) Inventors: Carl Lewis, Conwy (GB); Peter Hicks, Gorad Valley (GB); Sean Ganley, Colywn Bay (GB)

Correspondence Address: Kirk D Houser;Eckert Seamans Cherin & Mellott, 600 Grant St., 44th Floor, Pittsburgh, PA, 15219, US

(21) Appl. No.: 10/535,878

(22) PCT Filed: Nov. 10, 2003
(86) PCT No.: PCT/GB03/04844

§ 371 Date: Dec. 19, 2005

(30) Foreign Application Priority Data
Nov. 8, 2002 (GB) 0226113.9

(51) Int. Cl. H02B 1/01

(52) U.S. Cl. 361/627

(57) ABSTRACT

A miniature switchgear device 10, of the type used, for example, in power supply installation boards and consumer units, has a trip function for isolating an installation 52 from an electrical supply 50 depending on an electrical condition of the installation 52. The device 10 has a front face 14 configured to be accessible to a consumer during use. Means 62 are provided for generating a signal indicative of an electrical parameter of the installation 52 during supply of electrical current thereto. Means 16, 68, 70 are further provided for presenting an indication corresponding to the signal to the front face 14 for display to the consumer.

This invention relates to miniature switchgear devices. More particularly, but not exclusively, it relates to rail mounted miniature switchgear devices for use in electrical power supply installation boards and consumer units.

Miniature switchgear devices are conventionally operative to isolate an electrical supply from a load in response to a fault sensed in an electrical installation under protection. Such devices are typically configured to trip by means of an electro-mechanical mechanism operative to separate one or more electrical contacts in the supply line.

The design of such devices is subject to cost and space contraints. For example, a typical consumer unit has an outer casing within which the rail mounted miniature switchgear devices are housed. The outer casing has an opening to allow access by a consumer to a face of each device. The face of each device is provided with one or more consumer accessible components, which would usually include the lever of a trip switch and/or a function button and/or indicia.

The physical dimensions of the miniature switchgear devices are required to conform to industry standards such as those specified in the DIN standard 43380 “Built-in equipment; overall dimensions and related mounting dimensions”. In particular, the height of the face of the device is designed to fit the height of the opening of the casing. The width of the opening is designed to accommodate a number of devices mounted side by side. In practice, these design criteria have limited the available face area visible and accessible to the consumer.

In conventional devices the space restrictions, both internally within the device and on the front face, are such that the accommodation of consumer accessible components in the form of indicia relating to the origin (e.g. manufacturer's logo) and or rating of the device and trip switches is limited. In fact, in practice, the consumer accessible components have been limited to manufacturer/rating indicia and a trip lever to open or close the contacts of the device. These constraints have hitherto limited the functionality of these devices to simple circuit breaking as well as limiting the information visible to the consumer regarding the operation, rating and origin of the device.

A disadvantage of such devices is that no information is provided to the consumer about the electrical state of the installation under protection other than whether the device is ‘on’ or ‘off’, the latter condition being indicative of a possible trip due to an unspecified fault. Although it may be apparent to the consumer which of the devices within an installation has tripped by virtue of the relative position of the trip switch, no other information is provided. In other words, the device only provides an indication that a fault condition has occurred. The supply to the installation is interrupted until the fault is rectified. This can lead to inconvenient and costly down times of electrical equipment.

It is an aim of the present invention to alleviate this problem by providing information concerning the electrical state of the installation prior to tripping.

According to the present invention, there is provided a miniature switchgear device having a trip function for isolating an installation from an electrical supply depending on an electrical condition of the installation, the device comprising:

a front face configured to be accessible to a consumer during use;

means for generating a signal indicative of an electrical parameter of the installation during supply of electrical current thereto; and

means for presenting an indication corresponding to said signal to said front face for display to the consumer.

In a preferred embodiment of the present invention, the presenting means is embodied on or within a consumer accessible component of the front face of the device. The consumer accessible component may be a trip or reset lever, bezel forming part of the front face of the device, function button or indicia panel. In this way, the component on the front face performs an additional function, namely the presentation of information concerning the electrical parameter of the installation to the front face of the device so that it is visually accessible to the consumer. That is to say, the consumer is able to gain information regarding the electrical state of the circuit protected by the device simply by looking at the indication on the front face. Moreover, it is apparent that the additional functionality of information provision can be embodied into the conventional design layout of the front face of a miniature switchgear device, thereby overcoming space and functionality constraints.

A transducer may be provided within the device for sensing the electrical parameter and generating said indication signal in dependence thereon. The indication signal may be an optical signal conveyed to the consumer accessible component by way of a light transmitting conduit such as a light pipe or optical fibre. In one embodiment, the consumer accessible component itself may be formed from a translucent material and coupled to the conduit so that the optical signal generated by the transducer is made visible to the consumer. Alternatively, the indication signal may be electrical in which case a transducer is provided at the front face for converting the signal into a form which can be perceived by the consumer. For example, a light emitting diode (LED) may perform this function.

The transducer provided within the device may be a processor comprising means for sensing the electrical parameter and generating the indication signal. The electrical parameter monitored by the processor may be earth leakage and/or over-current and the indication signal may advantageously be such as to represent the absolute magnitude of the electrical parameter or level thereof relative to a predetermined threshold. For example, the device may therefore be operative to indicate to a consumer a ‘near’ over-current or earth fault situation before the device trips the supply. Devices embodying the invention can therefore advantageously provide early warning of an electrical problem so that the consumer can take remedial action before the device trips.

The transducer may be operative for generating signals indicative of more than one electrical parameter or more than one characteristic thereof. For example, the transducer may generate light signal patterns respectively representing different electrical parameters, or different characteristics of the same parameter. These patterns may be composed of any one or more of colour, frequency, intensity and duration of light signals (e.g. pulses). For example, the light may switch from green to red to indicate a ‘near’ trip condition.

It is envisaged that the information provided to the front face may be formatted such that a consumer operable receiving apparatus may detect it. The information received by the apparatus may be processed and analysed therein and displayed in consumer readable form on a suitable display. The information may be in the form of binary formatted serial data. The formatted data may be transmitted in the form of a modulated intensity of light or infra-red radiation. The frequency of the modulated intensity may be such that the modulation is not detectable by the human eye. The indicator may therefore be used for the dual purpose of providing visible information to the consumer, and providing formatted information to the receiving apparatus.

Alternatively or additionally, the information may be presented to the front face in the form of a plurality of point sources which together convey the desired information to the consumer. For example, more point sources of an array may be illuminated as the electrical parameter becomes closer to the level at which the device will trip.

In a further alternative embodiment of the present invention, the functionality or operational parameters of the device may be programmable. The programmable functionality may relate to the electrical parameter monitored by the device. For example, the level or rating at which the device will trip for a given over-current or earth leakage current may be selectable by the consumer. A user interface may be provided, accessible to the consumer on the front face of the device, for facilitating programming thereof. The user interface may be a button which when pressed in a predetermined sequence scrolls the programming function through a series of options which may be selected by the consumer. In this case the information presented to the front face may, either instead of or in addition to the representation of the electrical parameter, represent the programming functions or operational parameters scrolled and selected by the consumer.

The miniature switchgear device may be provided with a detection function and/or a protection function for any or all of: residual current, line current, over-current, line voltage, over-voltage, under-voltage, temperature, earth leakage current, power measurement and power factor. The miniature switchgear device may be a miniature circuit breaker (MCB).

Embodiments of the invention will now be described by way of example with reference to the accompanying drawings is which:

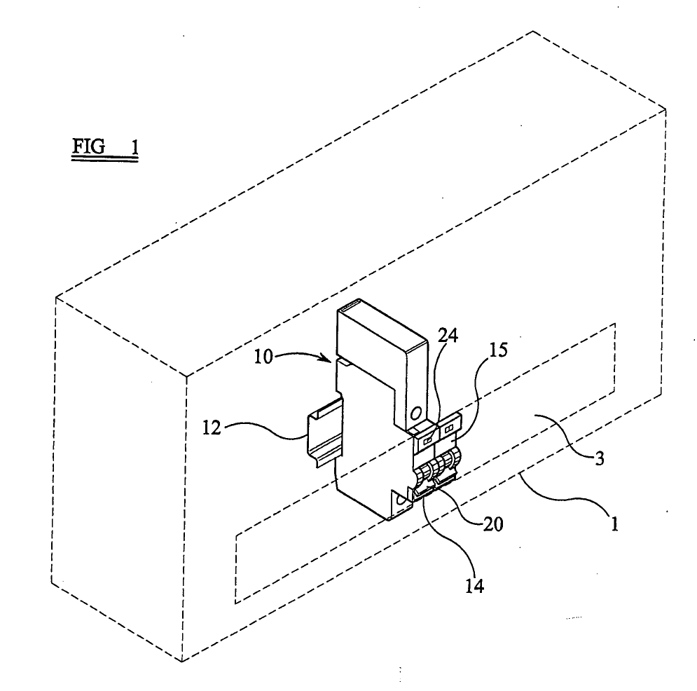

FIG. 1 shows a power supply installation consumer unit incorporating miniature switchgear devices;

FIG. 2 shows a miniature switchgear device in accordance with the invention;

FIG. 3 shows a portion of the miniature switchgear device of FIG. 1;

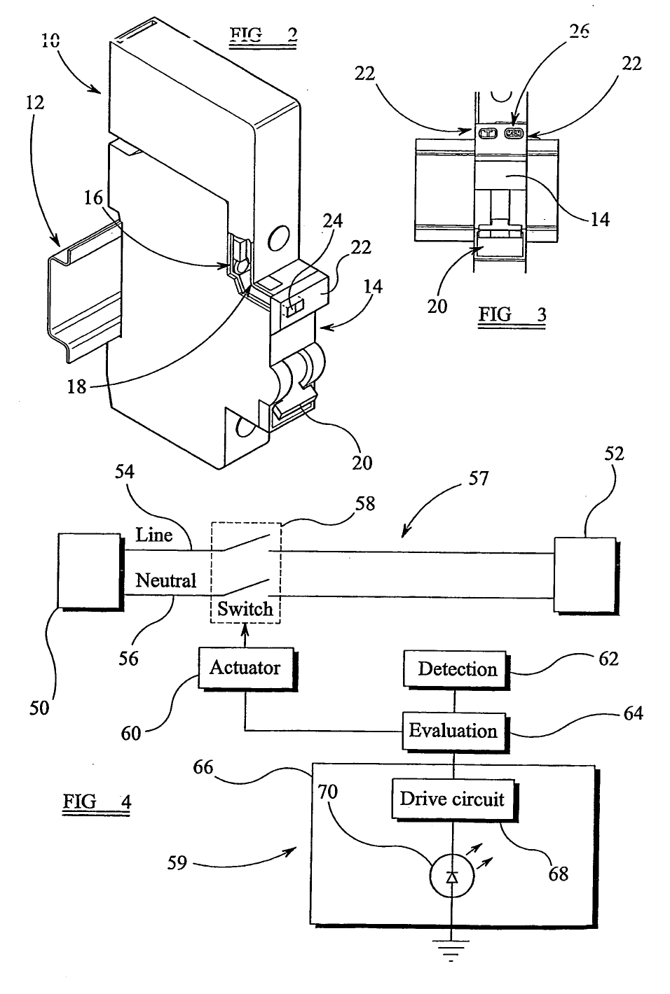

FIG. 4 is a schematic diagram showing electronic circuit features of the miniature switchgear device of FIG. 1; and

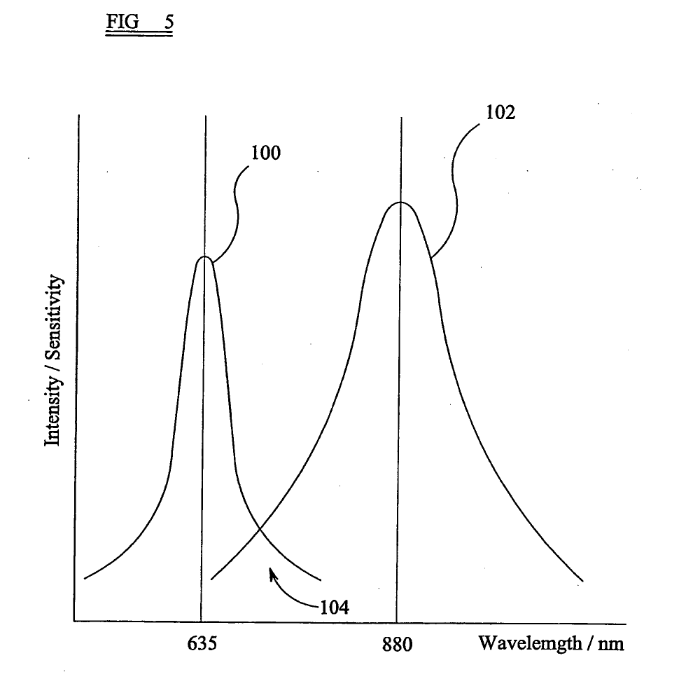

FIG. 5 is a graph showing emission intensity of a typical red LED and signal sensitivity of a typical infrared receiver as a function of radiation wavelength.

Referring to FIG. 1, a power supply installation consumer unit has a casing 1 shown in a broken line outline. The casing 1 has an opening 3 and houses an MCB 10 mounted on a rail 12 such that only a face portion 14 of the MCB 10 is visible in the opening 3. The MCB 10 is typically one of a number of similar devices mounted on the rail 12 such that only the face is visible to the consumer through the opening 3, as shown in FIG. 1 by the face 15 of another such device.

The device 10 and the rail 12 conform to the dimensions given in the DIN standard 43880 “Built-in equipment; overall dimensions and related mounting dimensions”. As can be seen in FIG. 1, the face 14 supports consumer accessible components which include a lever 20 of a trip switch and a function button 24. The function button 24 may be a test button for testing operation of the device and/or a button for allowing the consumer to select the operating function of the device. Limited space is available for providing any other components due to the restrictions of the face dimensions. Similarly, the dimensions of the device 10 are restricted to fit within the casing 1 and limit the space available for circuitry or other components inside the device.

The device 10 is typically a protection device for the electrical supply such as a residual current device or an over-current protection device. The device 10 operates in response to detection of a trip level of an electrical parameter of the installation. The electrical parameter is selected to provide an indication of a fault or unsafe condition in the electrical supply.

The device 10 contains a transducer for detecting the level of the electrical parameter and generating a signal which corresponds to the level. For example the transducer may be a winding on a transformer core in which a current is induced in proportion to a level of current imbalance in the conductors of the electrical supply. The device also includes a control circuit for operating the device to interrupt the supply when the level detected is at or above the trip level. Manual interruption and re-setting of the device by the consumer can be achieved by operation of the lever 20.

Referring to FIGS. 2 and 3, where identical features have the same reference numbers, the miniature switchgear device 10 has a light source in the form of an LED 16, shown in a cut-away portion of device 10 in FIG. 2. In addition to the switch lever 20 and button 24, a bezel 22 on the front face 14 forms a locator for the button 24 and a supplier's logo 26. An optical pathway in the form of a light guide passage 18 is provided for directing light from the LED 16 to provide illumination to the button 24. The button 24 is formed from a translucent material so that its illumination by light from the LED is visible to the consumer.

In use, the miniature switchgear device 10 causes the LED 16 to emit light according to the level of the electrical parameter detected by the transducer. For example the miniature switchgear device may be an RCD designed to operate a switch to isolate the supply on detection of a predetermined trip level of residual current. However, detection of a residual current below the trip level, but above a lower threshold level, causes the LED) 16 to emit light and illuminate the button 24. This provides an indication to the consumer that there is a fault condition in the supply circuit, which, although insufficient to cause the device 10 to trip the supply, may need to be investigated. Thus the LED 16, light guide passage 18 and button 24 (or other front face feature) together provide an early warning indicator.

In another embodiment, the processor of the device 10 is programmable to allow it to be used for one of a number of applications, or one of a number of different settings. In this embodiment, the indicator is used to indicate which application, or which setting has been programmed. For example, the miniature switchgear device 10 may be an over-current device programmable to trip a supply circuit at either a high current setting or a low current setting. If the high current setting is programnmed, the LED 16 is illuminated so that the consumer can tell by looking at the front face 14 that the device 10 has been programmed to operate at the high current setting.

Although the miniature switchgear device 10 shown in FIGS. 1 to 3 has a single LED) light source 16, a plurality of LEDs may be provided. The LEDs may each illuminate a different part of the front face or a different portion of the same component by suitable arrangement of optical pathways. Alternatively, the LEDs may each illuminate a component with a different colour of light. Alternatively the processor may incorporate a circuit which controls the LED 16 to modulate the level of intensity of light emitted. The level of intensity may be varied in a sequence of pulses or to provide a flashing light indication. These alternative arrangements provide for presenting different information to the consumer about the condition of the electrical supply being monitored or about the programmed configuration of the device. For example different numbers of LEDs, or different levels of light intensity, or different colours, or different rates of pulsed flashing light signify different levels of the detected electrical parameter.

Referring to FIG. 4, an electrical supply circuit 57 comprises an electrical supply 50 connected to a load 52 by way of live 54 and neutral 56 power lines. A switch 58 forms part of the electronic circuitry 59 of the miniature switchgear device 10 of FIGS. 1 to 3, and is actuated by an actuator 60 to isolate the power supply 50 from the load 52.

The electronic circuitry 59 includes a detection circuit 62 for detecting a parameter of the power supply circuit 57. Typically the parameter will be indicative of a level of a residual current, or a total current in the supply circuit 57. An evaluation circuit 6 evaluates a condition of the electrical supply circuit 57 based on the level of the parameter detected. If the evaluation circuit determines that an unsafe condition exists because the detected parameter exceeds a safe threshold, a signal is provided to the actuator 60 to open the switch 58 and isolate the supply 50 from the load 52.

The electronic circuitry 59 is further provided with an indicator circuit 66, which includes a drive circuit 68 and an LED 70. The LED 70 is arranged in the miniature switchgear device as the light source 16 of FIGS. 1 to 3. If the evaluation circuit 64 determines that the level of the parameter detected by the detection circuit 62 is below the threshold, but is high enough to indicate that a fault condition is present in the electrical supply circuit 57, then a signal is provided to the drive circuit 68 which causes a voltage to be supplied to the LED 70 so that the LED 70 emits light.

The light source used in the device 10 can also be used as a means of providing a serial data link. The indicator circuit 66 includes a processor (not shown) which is configured to control the drive circuit 68 to modulate the light intensity emitted by the LED 16 in a pattern which includes a binary formatted serial data stream. The serial data stream includes information relating to the operation of the device 10, such as the level of fault condition detected. The light emitted is received by a suitable receiver which is an interface for a receiving apparatus such as a portable computer for reading and analysing the information contained in the data stream.

Referring to FIG. 5, graph 100 shows that light emitted by a red LED has a peak intensity at a wavelength of about 635 nm. Graph 102 shows the sensitivity to radiation received by an infrared receiver, and has a peak sensitivity at a wavelength of about 880 nm. The infrared receiver will also detect radiation (at a much lower sensitivity) at wavelengths emitted by the red LED, albeit at a much lower intensity, as shown by the portion 104 where the two graphs 100, 102 cross. However the LED 16 used as the light source of the miniature switchgear device 10 of FIGS. 1 to 3, emits light at an intensity suitable for detection by a human eye, whereas to be capable of detecting a binary modulated serial data stream the infrared receiver need only detect a much lower radiation intensity. Therefore the binary formatted serial data included in the light emitted by the LED 16, when this is the red LED of graph 100, is detectable by the infrared detector.

The transmission rate of the binary formatted serial data is high so that the intensity modulation would not be noticeable to the user who would only detect whether the indicator light is on or off.

1. A miniature switchgear device having a trip function for isolating an installation from an electrical supply depending on an electrical condition of the installation, the device comprising:
a front face configured to be accessible to a consumer during use;
means for generating a signal indicative of an electrical parameter of the installation during supply of electrical current thereto; and
means for presenting an indication corresponding to said signal to said front face for display to the consumer.

2. A device according to claim 1, wherein the presenting means is embodied on or within a consumer accessible component of the front face of the device.

3. A device according to claim 2, wherein the consumer accessible component is a trip or reset lever, or a bezel forming part of the front face of the device, or a function button or indicia panel.

4. A device according to any preceding claim, wherein a transducer is provided within the device for sensing the electrical parameter and generating said indication signal in dependence thereon.

5. A device according to claim 4, wherein the indication signal is an optical signal conveyed to the consumer accessible component by way of a light transmitting conduit such as a light pipe or optical fibre.

6. A device according to claim 5, wherein the consumer accessible component is formed from a translucent material and coupled to the conduit so that the optical signal generated by the transducer is made visible to the consumer.

7. A device according to any one of claims 1 to 3, wherein the indication signal is electrical and a transducer is provided at the front face for converting the signal into a form which can be perceived by the consumer.

8. A device according to any one of claims 5 to 7, wherein the transducer comprises a light emitting diode (LED).

9. A device according to any one of claims 4 to 8, wherein the transducer provided within the device has a processor comprising means for sensing the electrical parameter and generating the indication signal.

10. A device according to any preceding claim, wherein the indication signal is such as to represent an absolute magnitude of the electrical parameter or a level thereof relative to a predetermined threshold.

11. A device according to claim 10, wherein the device is operative to indicate to a consumer a ‘near’ fault situation before the device trips the supply.

12. A device according to any preceding claim, wherein the means for generating a signal is operative for generating signals indicative of more than one electrical parameter or more than one characteristic thereof.

13. A device according to claim 12, wherein the signals are light signal patterns respectively representing different electrical parameters, or different characteristics of the same parameter.

14. A device according to claim 13, wherein the patterns are composed of any one or more of colour, frequency, intensity and duration of light signals.

15. A device according to any preceding claim, wherein the information provided to the front face is formatted so as to be detectable by a consumer operable receiving apparatus.

16. A device according to claim 15, wherein the information received by the apparatus is processed and analysed therein and displayed in consumer readable form on a suitable display.

17. A device according to claim 15 or claim 16, wherein the information is in the form of binary formatted serial data.

18. A device according to claim 17, wherein the formatted data is transmitted in the form of a modulated intensity of light or infra-red radiation.

19. A device according to claim 18, wherein the frequency of the modulated intensity is such that the modulation is not detectable by the human eye.

20. A device according to any preceding claim wherein the information is presented to the front face in the form of a plurality of point sources.

21. A device according to claim 20, wherein more point sources of an array are illuminated as the electrical parameter becomes closer to a level at which the device will trip.

22. A device according to claim 1, wherein the functionality or operational parameters of the device are programmable, the information presented to the front face, either instead of or in addition to the representation of the electrical parameter, representing the programming functions or operational parameters.

23. A device according to any preceding claim, wherein the device is provided with a detection function and/or a protection function for any or all of: residual current, line current, over-current, line voltage, over-voltage, under-voltage, temperature, earth leakage current, power measurement and power factor.

24. A device according to any preceding claim wherein the device is a miniature circuit breaker (MCB).
